(19) United States
(12) Patent Application Publication
(10) Pub. No.: US 2016/0267481 A1
(43) Pub. Date: Sep. 15, 2016

(54) System and method for distributed money supply

(71) Applicant: Svetoslav Lazarov Gramenov, Varna (BG)

(72) Inventor: Svetoslav Lazarov Gramenov, Varna (BG)

(21) Appl. No.: 14/656,724

(22) Filed: Mar. 13, 2015

(51) Int. Cl. G06Q 20/40; G06Q 20/06; G06F 17/30; G06Q 20/22

(52) U.S. Cl. CPC G06Q 20/405; G06Q 20/223; G06Q 20/40145; G06Q 20/06; G06F 17/30867; G06F 17/30368

(57) ABSTRACT

The present invention provides in at least one embodiment, a payment system with a method for distributed money supply. The system is implemented in a web environment where users interact with each other and a central authority with data processing devices through a network. Mediums of exchange in the system are public and private currency units. Public currency units are created by the operator of the system—a central authority while private currency units are created on the initiative of the users where each user is entitled to request the creation of his own currency. Currencies and currency units are managed by a server coupled to a database. The database stores data for every user and every currency. Currency data is stored in separated pieces of memory in the database—accounts. The server operates the currency issuance, transaction and redemption through the management of the currency accounts in the database on request of the users.

### BACKGROUND

1. Field of Invention

The invention applies to the implementation of a payment system in a closed web environment where users transact value on a peer-to-peer basis and are authorized to issue their own private money which circulates together with public money, issued by a central authority.

2. Description of the Related Art

### The Current Money System

The monetary system currently in use globally—scarcity-based, debt-based, fiat, government- and commercial bank-controlled, issued for profit against interest, with a built-in growth requirement and preferential attachment via interest—while assuring relentless growth during earlier times of scarcity, has become the root cause behind trade imbalances and currency wars, financial crises, depressions, resource depletion and climate change, income inequality, unemployment, poverty.

The main issue lies in the money supply mechanism and the way it affects the public and private financial, political and social relations. According to various researches over 97% of the money supply is debt-based, issued into circulation through the mechanisms of lending within a fractional reserve banking environment. This particular form of money supply—debt-based, issued for profit against interest—leads to serious problems like lack of money for public projects, strong income stratification within society, flow of wealth from the poor to the rich and growing disenfranchisement of those members of society who lack financial resources, resource depletion and intense competitiveness caused by the built-in growth requirement via the “interest” feature (money for the interest is not created and must be extracted from other debtors, i.e. bankruptcies for some members of the society or a constant—ever increasing—expansion of the economy are required).

The money supply in the current monetary system is top-down, centralized process. Decisions for national currencies are usually taken by central banks which cannot possibly know where exactly in the economy more money need to be injected. This phenomenon is commonly referred to as the “knowledge problem” of central banking. The knowledge problem forces regulators and the respective entities controlling the money supply to take decisions hoping that money will reach those who need it through investment, social spending and lending.

Perhaps one of the biggest issues with the current system is the inefficiency of the tools which central banks have at their disposal for management of the money supply. One of the main tools of central banking for control over the amount of money created by private banks through lending is the manipulation of the interest rate. Higher interest rate means less borrowing, thus decreased money supply, while lower interest rate should have the opposite effect. A huge problem with this top-down method for controlling the money supply is that it tends to kill the economy across the board when rates are increased, and, alternatively, to create speculative bubbles when rates are lowered. Fine-tuning of the central banking policies is further hampered by a time lag—the delay between a monetary decision of the central bank and its consequences in the real economy It is calculated that due to a variety of factors (fixed interest rates, lack of consumer knowledge, etc.) interest rate changes may take up to 18 months to have full effect. Finally, as recent empirical evidence demonstrates, provision of liquidity by central banks into the banking system does not necessarily translates into healthy funding for new projects and economic growth, but instead may morph within the commercial banking system into hoarding and speculation.

The money system currently in use also lacks an automatic anchor for its store of value function. Previously that function was carried out by gold, via the so called “gold standard” mechanism. Currently, no such anchor exists, and the value of money is largely dependent on the (possibly politically motivated) policies of governments/central banks. This leads to inflation, currency wars and trade unbalances.

Money, newly issued for profit only, leads to self-fulfilling asset-price bubbles, with the undesirable consequences once the bubble bursts as asset prices are destroyed but debts incurred for the acquisition of assets are not.

The financial sector is also vulnerable to periodic crises through the fractional reserve banking, and via the size and complexity of the derivatives markets. Within that setup the payment system is exposed to credit risk mismanagement, maturity transformations mismanagement, and other typical financial system risks which should not be allowed to interfere with the very fundamental function carried out by the payment system.

Most currency units are national, making the money system fragmented and prone to currency and trade wars.

### The Bitcoin

n the Bitcoin system a fixed limit of bitcoins is set which can be issued and the amount of money constantly rises in a somewhat fixed rate until it reaches this limit. The process of money issuance is related to the transaction of bitcoins. In order for transactions to happen users of bitcoins must spare some of the computing power of their devices. Their incentive for doing so is the fact that they are rewarded with a small amount of newly created bitcoins. This form of money supply is ineffective since it keeps no account of and recognizes in no way the actual need of money in the system. This will eventually prevent bitcoins and other digital currencies which are issued in the same or similar way, to be an effective medium of exchange.

### Time Banks

Time banks are a kind of money system which uses a time-based currency, most often measured in hours, and used within closed communities as complementary currency to the existing legal tender currency. One hour of community service is awarded with one unit of the currency issued either by a centralized authority or by the beneficiaries of the work. The time bank system emphasizes the social function of money, rather than the commercial exchange of goods and services. The problem of the system comes from the money supply mechanism—money can only be created for community work. Participants involved in such schemes are not so willing to transact goods and services but to perform charitable services. Also, there is only one price for all kinds of work, which has a strong discouraging effect for the provision of high value-added work under the scheme.

### LETS (Local Exchange Trading Systems)

The members of the mutual credit unions have an account in some monetary units which are most often dependent on the money which has legal tender in the society where the system is based, i.e. the US dollar. The account has a single value, represented by a number, which fluctuates with time and can be positive or negative. When a participant in the union buys good or services his account is debited and when he sells—the account is credited. All commercial relation in the system happen among the members of the union thus the combined balance of all accounts is always zero. No interest is accumulated. The problem of these systems is that they only serve private small scale commercial transaction. A participant can only receive as much goods and services as is equivalent to what he can provide to the other members and as long as they are willing to accept it. Mutual credit unions can only work in a relatively small, closed system of businesses which are based largely on trust, and are therefore in constant commercial relations between each other.

### Commercial Discounts, Coupons, Frequent-User Points/Benefits

Airlines, supermarkets, car rental companies and a number of commercial entities have a variety of programs designed to reward various high-volume customers. These commercial entities essentially issue their own private money in the forms of tokens, coupons, points, etc. which can be redeemed with the issuer. None of these schemes have the breadth and scope required of a genuine broadly based money system.

### Other Local Currencies

Local currencies present an optional medium of exchange which circulates together and alongside with the national currency in a geographically restricted community, i.e. a city or a municipality. Such currencies have no legal tender and must rely on incentives for individuals and entities in order to be perceived as convenient and preferable. Common incentives include beneficial exchange rates upon trade for national currency and the pure fact that using local currencies will prevent money from escaping the boundaries of the community and thus a social and economic progress is supposed to be achieved. These currencies may represent a physical implementation of the aforementioned financial systems (The Makkie in the Netherlands implements a time bank scheme with physical banknotes), mimic the structure of the national currency (The Bristol Pound in England is bound with the British Pound and has similar characteristics) or even implement a “sui generis” medium of exchange (Ithaca Hours in the US is a time-based currency tradable for US dollars at a fixed rate). The usage of local currencies is beneficial for the community within the set geographic boundaries. This however is one of the main weaknesses of the said schemes. Once the currency is allowed to circulate outside of the local community the beneficial effect on this particular community is lost since the money then becomes a mere alternative, a complementary currency to the national one. With no other advantage except for its local usage, a local currency which is no longer local, will not withstand the competition of money which has a legal tender in society.

### Virtual Currencies

Virtual currencies, also known as digital currencies, are the contemporary equivalents of the aforementioned currency schemes. The developing information technologies (IT) became a catalyst for the undergoing boom of various virtual currencies. Different developers take different approaches. Some consider it better to create centralized currencies (FinCEN defines centralized currency schemes as such that are operated by a central administrator and stored in a central repository) while other choose to develop decentralized models (Crypto-currencies are most often decentralized schemes where users are in possession of the money and exchange it on a peer-to-peer basis without intermediaries).

Although virtual currencies overcome some of the disadvantages of the current monetary system (low transaction costs, P2P transactions, real-time value transfers), they have problems that emanate from their design in the first place and create problems that often occur in the future (For example the fixed amount of money in circulation and the growing numbers of users of the currency make most currencies imminently deflational in time). Society is yet to witness the creation of virtual currency scheme, based on the modern achievements of information technologies, that takes into accounts and solves all the problems of the current monetary system.

### The Proper Monetary System

A proper money supply mechanism must ensure that there is an optimum quantity of money to facilitate the exchange of goods and services. New money must be issued as long as it is backed by newly created wealth and must fully cover this wealth. This balance can only be achieved when the wealth creators are directly responsible for the issuance of new payment media (i.e. money), moreover media that is to be extinguished upon redemption with those same wealth creators, together with a central authority that is responsible for issuing new money for community service and public goods on behalf of the society at large.

### REFERENCE TO SPECIFIC DOCUMENTS RELATED TO THE INVENTION

### US Patent Documents

Application Ser. No. 13/584,717, Nov. 6, 2014;
Application Ser. No. 14/268,822, May 2, 2014;
Application Ser. No. 13/198,905, Aug. 5, 2011;
Application Ser. No. 13/216,333, Aug. 24, 2011;
Application Ser. No. 11/975,723, Oct. 18, 2007;
Application Ser. No. 13/891,920, May 10, 2013;
Application Ser. No. 12/754,810, Apr. 6, 2010;
Application Ser. No. 13/443,308, Apr. 10, 2012;
Application Ser. No. 11/051,514, Feb. 4, 2005

### SUMMARY

This section of the current specification explains the solutions that the invention offers for the problems pointed out in the background.

Two types of currency, created under the same pattern, can be created in the system—private currency units and public currency units. Both of these currencies are created through a bottom-up method on the initiative of the users. A private currency is created on the initiative of a certain user who will be referred to as the issuer of the currency. Since a user is entitled to create currency units to be used as a medium of exchange in the system he is also obliged to redeem this currency for the goods and services that he offers in the system. When currency units are paid back to their issuer they are extinguished. Thus data for the issuer is intrinsic to private currencies. If n number of users participate in the system, then n number of different private currencies can be created.

Given the described characteristics of private currencies it is important that they do not have a legal tender status in the system with respect to any user other than the issuer. Users should have freedom of choice in privately issued currencies—the right to reject or accept payments with specific private currency units. This rule, however, does not apply to the issuer of the private currency unit himself with respect to his own private currency. When acting as a payee in a transaction which involves currency units issued by him, he should not be able to reject the transaction.

Public currency units, on the other hand, are issued by a central authority in the system which performs public-management functions in the system on behalf of the users of the system. Public currency units are issued at times, under circumstances, and in amounts as specified in the so called “social contract” of the users of the system. The philosophy behind the public currency is fundamentally different from the philosophy of the private currencies—whereas the private currencies are IOUs of the issuer, the public currencies are a way for users to collectively pay for certain goods and services, such as provide basic education for the needy, or care for the elderly and sick. Public currency also allows the implementation of an Employer of Last Resort program with virtually unlimited funding—certain activities performed for the benefit of society at large (such as communal upkeep and maintenance for example, or reforestation) can be financed with newly issued public currency units. Once issued, the public currency units are not redeemable in the goods and services of any particular issuer—they are not extinguished upon redemption as in the case of private currencies. The public currency also has a legal tender status in the system.

The system is web based and users interact with each other and a server, operated by the central authority through data processing devices. The server is also coupled through a database where data for the users, the currencies and the transactions is stored. Currency data is recorded in the database in separate pieces of memory—accounts. Each account refers to a single user and a single type of currency. Ac private currency account has three parameters—issuer of the currency, owner of the currency and amount of currency units in the account. Public currency accounts do not have data for currency issuer.

When currency units are created on the initiative of a user or when a user receives certain currency units through transaction the server creates an account for the user and this specific currency if such account does not already exists. If an account exists the server alters its value parameter in the database.

### BRIEF DESCRIPTION OF THE DRAWINGS

FIG. 1 illustrates the bottom-up money supply mechanism in the system at large.

FIG. 2 represents the process of private currency issuance as a sequence of interactions between different participants in the system.

FIG. 3 depicts a sub-process in the private currency issuance mechanism—verification of issuance conditions.

FIGS. 4.1 and 4.2 show two possible implementations of the public currency issuance mechanism in the system in relation to community services and social security.

FIGS. 5.1, 5.2 and 5.3 illustrate the three different variations of transaction mechanisms in the system according to the type of currency involved in the transaction.

FIGS. 6.1, 6.2 and 6.3 represent the mechanisms through which the server manages transactions by altering currency related data in the database.

### DETAILED DESCRIPTION

An example embodiment, as described below, may be used to provide a payments system and a method for operating a payment system with distributed money supply. Different aspects of the invention are described in details in the following paragraphs.

### Implementation Environment

The below described method for distributed money supply can be applied in a system implemented in a network environment. The system should include at least users and a central authority which has control over a database where user data and money data is stored. Preferably a secure identification procedure is used for granting access to the system. Such procedure can be a biometric identification of the users. Furthermore a method for peer-to-peer authentication may be applied where a user are authenticated by a certain number of the rest of the users. For example if enough users state that a certain user is Bob than when this user is identified in the system through biometric identification, he will automatically be recognized as Bob.

### Money Supply Mechanism at Large

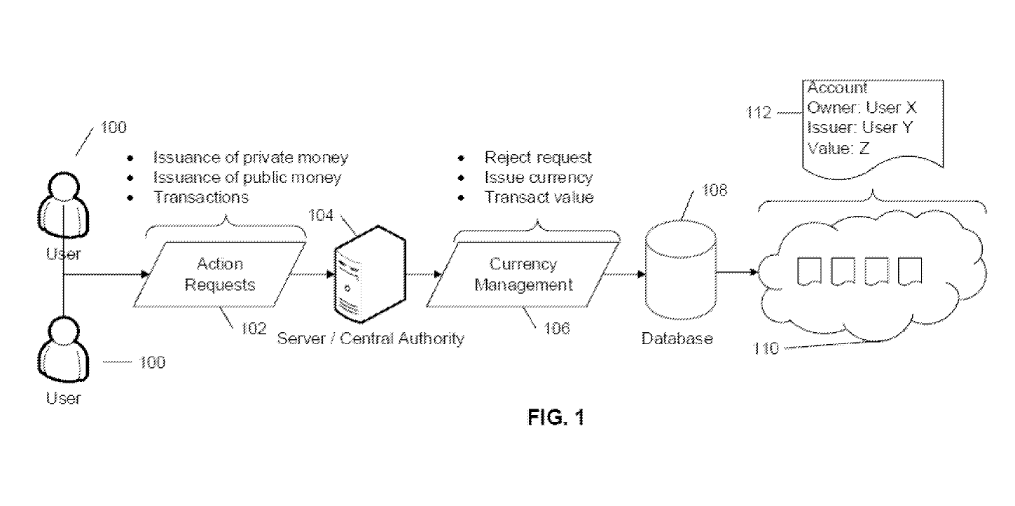

The basic steps in the process of currency issuance and value transaction in the system will be explained with reference to FIG. 1. In order for new currency units to be created or existing currency to be transacted in the system users (100) must interact with a server (104) which is illustrated in FIG. 1 as central authority of the system. The system is web-based and interactions between users and the server are executed through data processing devices which are not depicted in FIG. 1. A data processing device should be any device capable of sending and receiving data through the network and visualizing and interface for interactions. The server (104) is coupled to a database (108). The database is used for storing data for the users and the currency dynamics in the system.

The currency issuance and transaction process has an implemented bottom-up approach. It is initiated when a user (100) submits an action request (102) to the central authority (104). As indicated in FIG. 1 the action request may be for issuance of private money, issuance of public money or transaction of money. When speaking of money in the current specification one should associate this concept with currency units. The action request (102) is handled by the central authority (104) which then starts the process of currency management (106). During the currency management the central authority may check is some preset conditions for executing the requested actions are set and respectively execute the action or reject the request.

The server (104) executes actions upon requests of users by altering data in the database (108). Currency information is stored in separate pieces of memory—accounts (110). Private currency accounts (112) have three parameters—an owner parameter which refers to the owner of the currency units in the account, issuer parameter which refers to the user for whose goods and services the currency units can be redeemed and value parameter which indicates how much currency units are stored in the account. The server issues and transacts currency either by creating new accounts in the database or by managing the value parameters of existing accounts.

### Private Money Supply

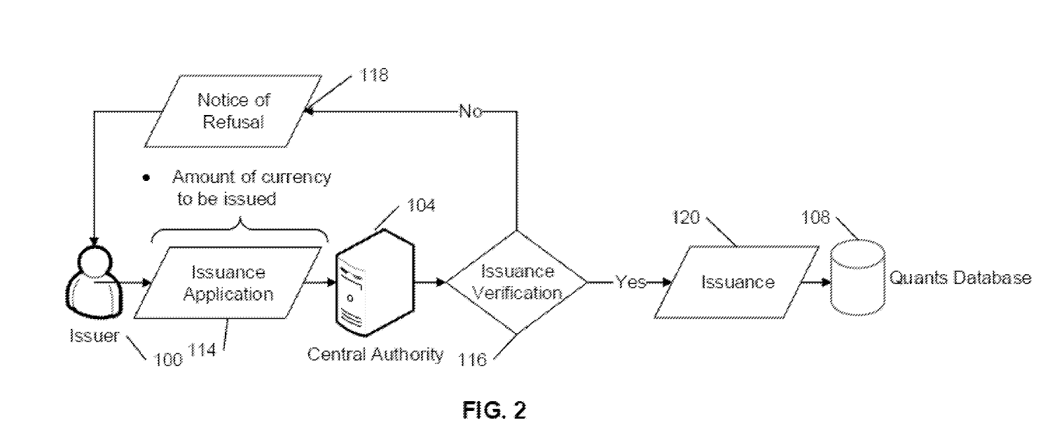

The sample process flow of the private currency supply mechanism is depicted in FIG. 2. The process starts on the initiative of a user, acting as an issuer (100). The issuer (100) sends through his data processing device an issuance application (114) to the server (104). The information in the included in the issuance application (114) should include the amount of currency units to be issued.

The application is handled by the central authority (104) which executes a verification procedure (116). This procedure should verify whether certain preset conditions for issuance are met. It will be further explained below. If the conditions are not met, the server automatically sends a notice of refusal (118) to the issuer (100). Preferably this notice includes at least the reason why the issuance application (114) has been rejected.

If the issuance requirements are met the server (104) creates new currency units (120) through interaction with the database (108). If the issuer (100) has never issued currency units in the system before the server (104) will create a new account in the database (108). It will be a private currency account with the following parameters: owner parameter will refer to the issuer since he is the first owner of the currency; issuer parameter will also refer to the issuer since he is the user upon whose request the currency has been created; value parameter will be the same as the amount of currency units indicated in the issuance application (114). If however the user (100) has issued currency units before than an account for such private currency already exists. The only thing that the server (104) has to do is alter the value parameter of the account in the database (108) incrementing it with the amount of currency units indicated in the issuance application (114).

### Private Currency Issuance Verification

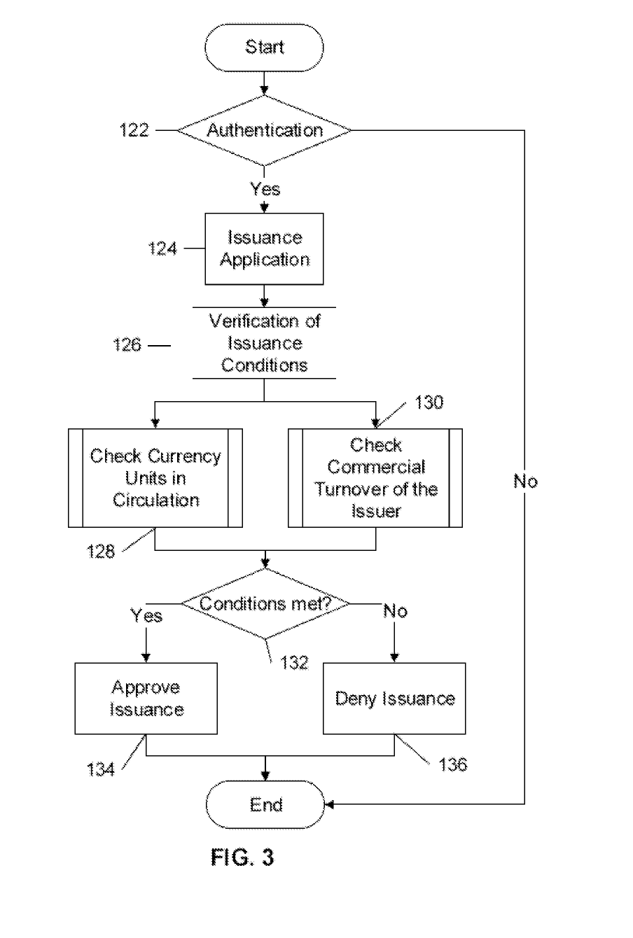

An example issuance verification procedure is depicted in FIG. 3. The purpose of the procedure is to limit the money supply according to conditions and requirements preset by the operator of the system—the central authority. The first mandatory step in the procedure is the authentication of the issuer (122). Only an identified user is entitled to issue private currency and participate in transactions. Data for the users together with the necessary credentials data is stored in the database. After the authentication the user sends an issuance application (124) to the server through his data processing device. At this point the essential verification procedure starts. The server has to verify that the issuance conditions are met (126). Whether an issuance is possible or not should depend on the total number of currency units issued by that user (128) compared to his commercial turnover in the payment system (130). The total number of currency is easily measured since all the data for issued and extinguished currency is kept in the database. The commercial turnover of a user is measured through a preset measuring period. During this time the server records all the transactions in which the issuer acts as a payee and detects which transactions are commercial. So the permitted quantity of currency to be issued depends on how much currency the issuer can redeem in the system for his goods and services and how much currency units he has already issued. The purpose of the issuance verification procedure is to limit excessive money supply. The specific conditions should be set by the operator of the system.

Only two outcomes are possible at the end of the issuance verification procedure depending on whether the issuance conditions are met or not (132). If they are indeed met the procedure will result in allowed issuance (134) and the server will process the issuance application and create the respective currency units in the database. If not however the issuance will be denied (136) and the applicant will receive a notice of refusal.

### Public Currency Supply

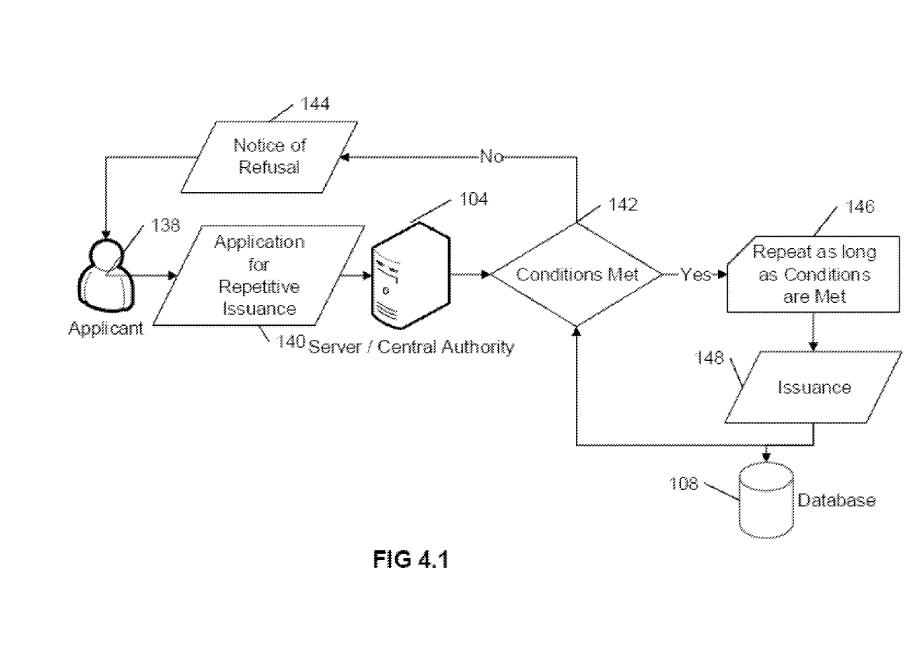

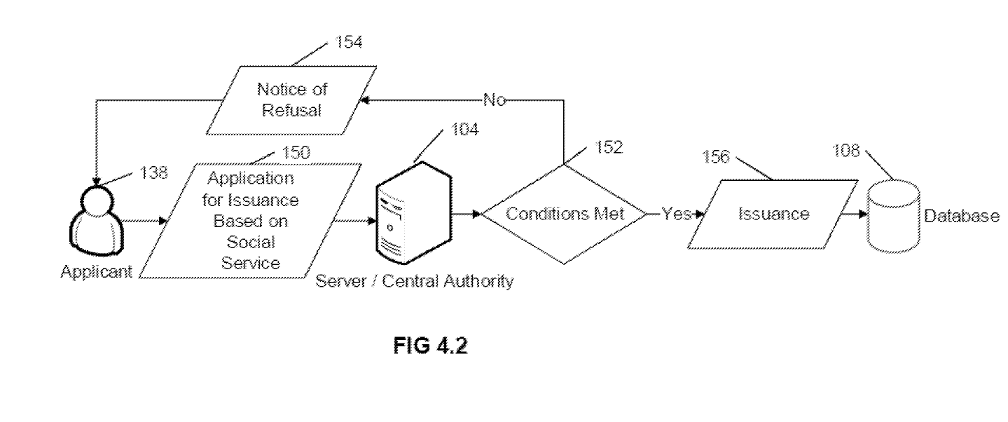

The process of public money issuance in the payment system is similar to the private money method. It will be explained with reference to FIG. 4.1 and FIG. 4.2. These figures illustrate two example methods for public money issuance for social spending.

FIG. 4.1 shows a procedure for repetitive issuance of public currency units. It can be applied to pensions, social welfare and other. The process starts when a user acting as applicant (138) submits an application for repetitive issuance of public currency units (140) to the central authority (104)—the server. The server than checks if the conditions for issuance are met (142) through an issuance verification procedure similar to the on explained with reference to FIG. 3. If the conditions for issuance are not met the server sends a notice of refusal (144) to the data processing device of the applicant. If however the conditions are met the server will execute a repetitive issuance loop. As long as the conditions are met (146) the server (104) will interact with the database (108) in order to issue the respective amount of currency units (148) in the account of the applicant. If at a certain moment the conditions are no longer met the server will interrupt the process and send a notice of refusal to the applicant.

FIG. 4.2 on the other hand represents the process of a single non-repetitive public money issuance. The process again starts with an issuance application (150) sent by a user acting as applicant (138) to the central authority (104). The user should include in the issuance application the prerequisites for the issuance, in the current example a social service. The central authority (104) checks if the issuance requirements are met (152) and if so issues the requested amount of public currency units (156) in the account of the applicant in the database (108). If the conditions are not met a notice of refusal (154) is sent to the applicant (138).

The issuance conditions for both types of public currency issuance procedures should be preset by the central authority. Depending on what exact conditions are the issuance verification procedure can be executed automatically or manually.

The public currency can be used in various situations. For example it can enable the central authority to act as an employer of last resort in the system. When a user performs some sort of public work the central authority can issue the respective amount of currency units directly in his account. The public currency is “net of debt”. There is no specific user who is obliged to provide goods and services in exchange for this currency as is the case with private currencies. The public currency has an automatically applied legal tender status in the system and users are not entitled to refuse payments with public currency units.

### Transaction Rules

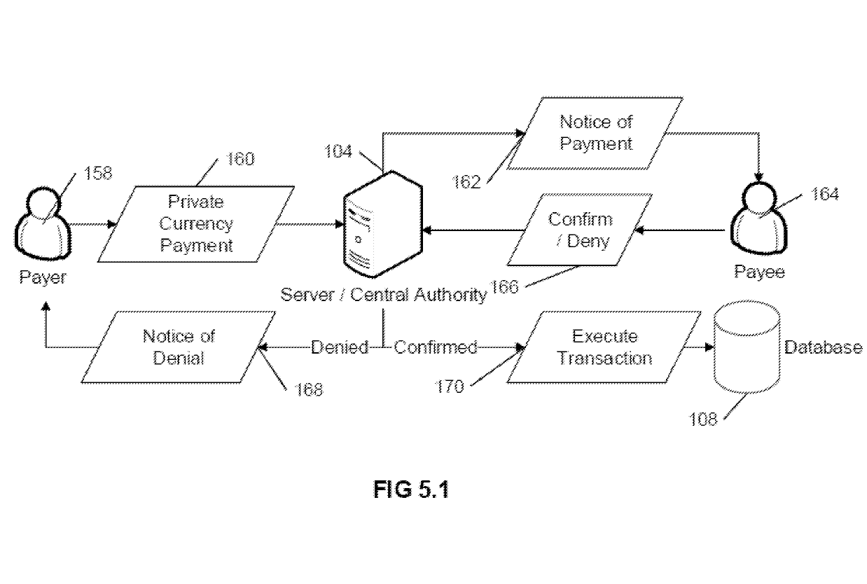

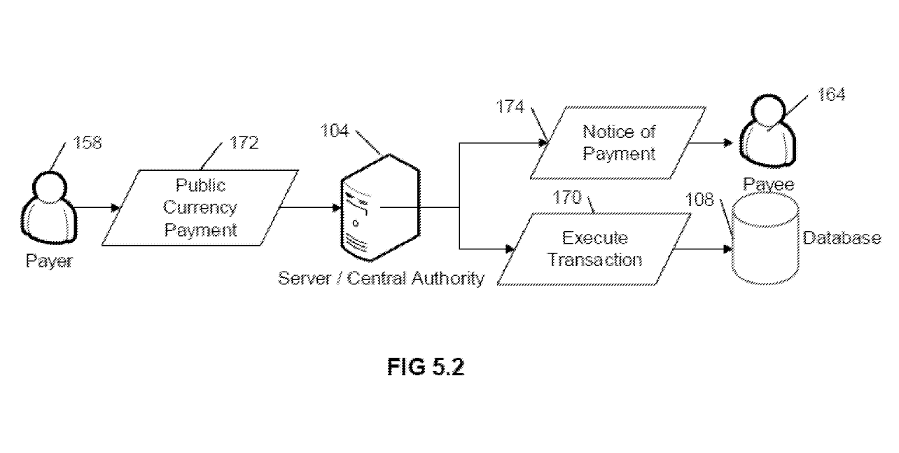

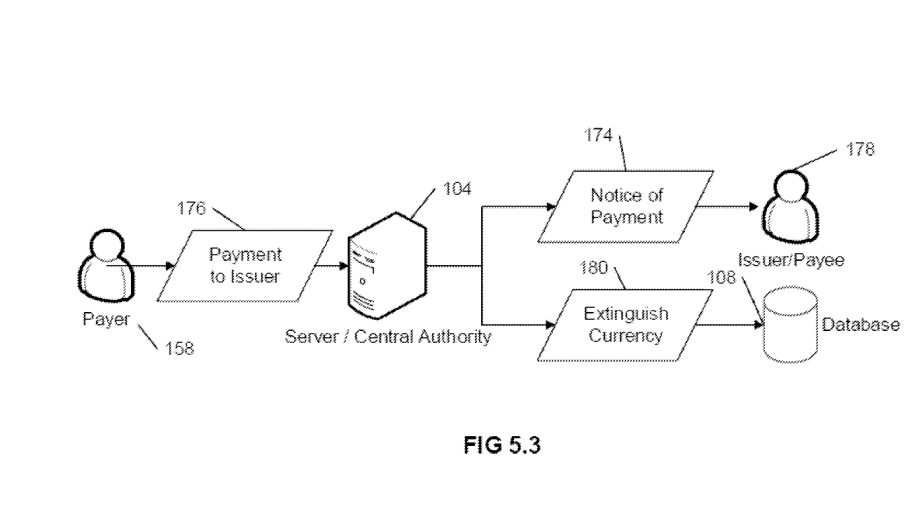

The money supply mechanism is the first major mechanism in the system. The other crucial aspect of the invention is the value transaction mechanism in the payment system. The basic rules of the transaction process will be explained with reference to FIG. 5.1, FIG. 5.2 and FIG. 5.3. These figures represent the three possible variations of the payment process depending on the type of currency units and the users involved in the transaction.

FIG. 5.1 depicts a payment procedure with private currency units where the payee is different than the issuer of the currency used in the transactions. The payment is executed through the interaction between the users and the server. A user, acting as a payer (158), sends a request for payment with private currency units (160) to the server (104). The server checks the type of currency and the payee indicated in the payment request. Since the requested transaction involves private currency units and the payee is not the issuer of this currency, the confirmation of the payee is necessary for the execution of the transaction. The server (104) sends a notice of payment (162) to the payee (164) which can either confirm or deny the transaction (166) by sending the respective message to the server (104). Depending on whether the transaction is confirmed or denied the server either executed it (170) by altering the data in the respective accounts in the database (108) or sends a notice of denial/refusal (168) to the payer (158).

FIG. 5.2 shows the payment procedure process with public currency units. Since public currency units have an automatically applied legal tender status in the system users are not entitled to refuse payments with such currency units. The process once again starts with a payment request (172) sent by the payer (158) to the server (104). Since the transaction involves public currency units the confirmation of the payee is not necessary for the execution. The server sends a notice of payment (174) to the payee (164) and executes the transaction (170) through altering the respective data in the database (108).

FIG. 5.3 illustrates the last possible payment mechanism—transactions with private currency units where the payee is the issuer of the private currency. The basic rules governing this kind of transactions are that the issuer cannot refuse to accept payment with currency units issued by him and that currency units transferred to the issuer are extinguished. Once again a payer (158) sends a payment request (176) to the server (104). The server establishes that the payee is the same as the issuer of the currency and no confirmation for the transaction is necessary. A notice of payment (174) is sent to the payee (178) and the currency units involved in the transaction are extinguished (180). When currency units are extinguished the server only alters the data in the account of the payer in the database but does not make any changes to the account of the payee.

Transactions in the system are governed by three simple rules: transactions with private currency need to be confirmed by the payee; transactions with public currency need no confirmation by the payee; transactions with private currency to the issuer also don't need confirmation and the units involved in the transaction are extinguished.

### Payments as Interactions Between the Server and the Database

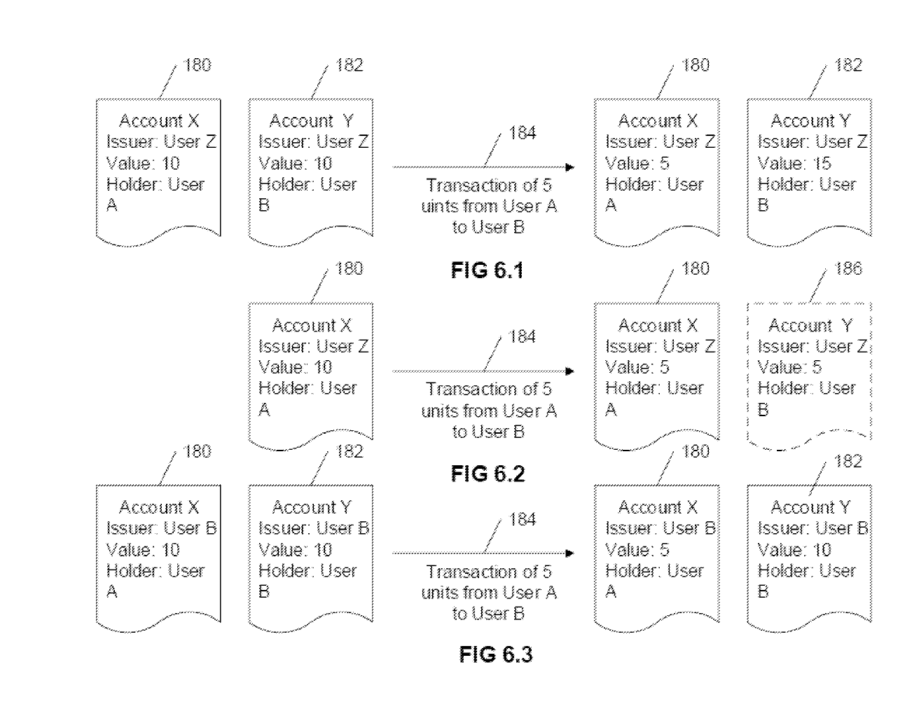

The interaction between the server and the database upon transactions will be explained with reference to FIG. 6.1, FIG. 6.2 and FIG. 6.3. These figures show how the server alters the accounts in the database in order to execute different type of transactions.

FIG. 6.1 shows a payment with private currency units where the payee already has an account created for the said currency units. Two users are involved in the transaction—User A and User B. When User A requests a transaction of 5 currency units (184), issued by the User Z and the transaction is confirmed by the payee, the server alters the value parameters of the respective accounts. The value parameter of the account of the payer (180) is decremented with the amount of the transaction and the value parameter of the account of the payee (182) is incremented with the same amount. Both accounts only store private currency units issued by the same user.

FIG. 6.2 depicts a payment with private currency units where the payee does not have an account for such currency units but has confirmed the payment. This means that this is the first time that the payee receives such currency units. The server decrements the value parameter of the account of the payer (180) by the requested amount (184) and has to create a new account for the payee (186). The new account has the following parameters: the issuer parameter holds data for the issuer of the currency used for the transaction—User Z; the value parameter corresponds to the amount of units involved in the transaction; the holder parameter refers to the payee—User B.

FIG. 6.3 illustrates a payment with currency units issued by the payee. According to the rules of the payment system currency units involved in such transactions must be extinguished. In the current example when User A requests a payment of 5 currency units to User B (184) the server will decrease the value parameter of the account of the payer—User A (180) with 5 but will not increase the value parameter of the account of the payee—User B (182). By executing this action the server basically extinguishes the currency units in the transaction.

It will be evident that the invention can be implemented in various embodiments that include some or all of the aspects described in the current specification. The invention offers one possible solution for optimum money supply and its democratization which will lead to a long term sustainable financial model.

What is claimed is:

1. A payment system for performance of distributed money supply, implemented in a web environment with a plurality of users, the system comprising:
1) a multitude of data processing devices capable of sending and receiving data over the network and visualizing an interface for interacting with other users and a central authority;
2) a least one device—a server, capable of sending, receiving and handling data over the network, coupled to a database and able to store and manipulate data in the database,
where the database is used for storing: user data, including credentials and identity of the users of the system; data for currency in the system, where the currency is created on the initiative of the users upon interaction with the server; the currency being created as accounts where each account has three parameters:
1. a parameter referring to the owner the currency, indicating which user owns the currency units in the said account;
2. a parameter referring to the issuer of the currency, indicating the user upon whose initiative the currency units have been created;
3. a parameter referring to the value of the account, indicating how much currency units are stored in the account; where value transactions in the system are executed by the server through the alteration of the value parameters in existing accounts in the database.

2. The system of claim 1 wherein users are identified through a biometric identification procedure.

3. The system of claim 1 wherein an peer-to-peer based authentication method is implemented, where user identity is established through confirmation by a minimum number of other users in the system.

4. The system of claim 1 where a central authority, operating the system, is entitled to create public currency units, the public currency units data being stored in the database in separate accounts which only have an owner and a value parameter and no issuer parameter.

5. The system of claim 4 where public currency units are also created on the initiative of the users of the system after an issuance verification procedure, executed automatically by the server or manually by the operator of the system, the purpose of the system being to establish if certain preset issuance conditions are met or not.

6. The system of claim 5 where the following transaction rules are implemented:
1. users are entitled to refuse payment with private currency units but only if the user is not referred to as the issuer of the currency units;
2. users are not entitled to refuse payments with public currency units;
3. when private currency units are transferred to a user, who is referred to as their issuer the currency units are not recorded in the respective account in his database but extinguished.

7. A method for distributed money supply and execution of transactions in a payment system with a multitude of private currencies, created under the same pattern on the initiative of different users, and a public currency, created by the operator of the system, the method comprising:
1. a procedure for creating private currency units, the procedure comprising:
1.1 a user sending over a network through a data processing device a request for private currency units creation, the request including at least the amount of currency units requested for issuance;
1.2 the request being handled by a server which executes the transaction through alteration of data in a database used for storing data for users and currency in circulation, where creation of private currency units is
1.3 either executed through the creation of a new separate piece of memory in the database—an account with the following parameters: owner parameter, referring to the user, who owns the currency units, issuer parameter, referring to the user upon whose initiative the currency units have been created and value parameter, referring to the number of currency units in the account, where the initial value parameter equals the desired amount of currency units in the issuance request, or
1.4 if such account already exists the issuance being executed through incrementing the value parameter;
2. a procedure for transacting private currency units in the system, the procedure comprising:
2.1 a user sending a transaction request to the server, the transaction request including at least a reference to the payee, the exact currency units and their amount used for the requested payment;
2.2 the server handling the request and establishing if the payee is the same user as the one referred to as issuer of the currency units;
2.3 if the user is referred to as issuer of the currency units, the server altering the value parameter of the respective account of the payer in the database by decrementing the value parameter of the payer's account with the respective amount of currency units and sending a notice of payment to the payee;
2.4 if the payee is not referred to as the issuer of the currency, sending a request for confirmation or refusal of the payment where if the user accepts the payment, the server executing the transaction by altering the value parameters of the respective accounts of the payer and the payee in the database by decrementing the value parameter of the payer's account and incrementing the value parameter of the payee's account with the respective amount of currency units and sending a notice of payment to the payers and if the user declines the transaction, the server sending a notice of refusal to the payee.

8. The method of claim 7 wherein the operator of the system is entitled to created public currency units, the public currency units created under the same patter as the private currency units except for the lack of an issuer parameter the public currency units being transacted in the system without the need of confirmation by the payee.

9. The method of claim 8 where public currency units are created on the initiative of the users of the system after an issuance verification procedure the purpose of which is to automatically or manually establish if certain requirements set by the operator of the system are met.

10. The method of claim 7 where upon executing a transaction the server extracts data for the payer, the payee and the amount of currency units involved in the transaction, the data being used to measure the commercial turnover of user in the system over a preset period of time.

11. The method of claim 10 where the data recorded for the commercial turnover of a user is used to set limits for issuance of private currency units, the limit depending on the number of units issued on the initiative of the user compared to the commercial turnover of the user.
